(19) United States
(12) Patent Application Publication
(10) Pub. No.: US 2011/0146563 A1
(43) Pub. Date: Jun. 23, 2011

(54) MAGNETIC EXCAVATION SAFETY MARKER

(76) Inventors: Richard Crawford, Vancouver, WA (US); Jamey Whitters, Vancouver, WA (US)

(21) Appl. No.: 12/973,510

(22) Filed: Dec. 20, 2010

Related U.S. Application Data
(60) Provisional application No. 61/288,834, filed on Dec. 21, 2009.

(51) Int. Cl. G01D 5/12

(52) U.S. Cl. 116/204

(57) ABSTRACT

A magnetic excavation marker is described below that includes a magnet and a stiff, resilient and brightly colored visual indicator. The marker is used by placing the marker onto an object to be protected, such as a manhole cover or valve. The magnet attaches the marker to the protected object with magnetic force. The marker will then protect the object by providing a highly visible indication of the presence of the object, even if the object is buried. The stiff and resilient qualities of the visual indicator ensure that it will remain upright and visible, even after it has been stepped on or run over. A handle is attached to the magnet or to a housing holding the magnet. The handle gives a user added leverage to aid in overcoming the force of the magnet when the user desires to remove the maker from the protected object.

### CROSS-REFERENCE TO RELATED APPLICATION

This application is a nonprovisional application claiming priority to copending provisional patent application Ser. No. 61/288,834, filed Dec. 21, 2009, which is incorporated herein by reference.

### FIELD OF THE INVENTION

Applicant's magnetic excavation safety marker is directed generally to markers used in excavation projects, and more particularly to resilient excavation markers with magnetic attachment mechanisms.

### BACKGROUND

Various types of markers are used in the construction industry. Grade markers are used to indicate the level to which workers should grade or back fill a surface. Surveying markers serve to indicate boundaries or the locations of future structures or excavations. Excavation safety markers serve to indicate where an object, such as a valve or manhole cover, has been buried, thereby protecting the buried object from damage when the area around or above the object is later re-excavated.

Previously, excavation safety markers have typically been nothing more than stakes on the surface of the ground above the buried object. This has not been a completely satisfactory solution because the stakes are vulnerable to being broken off or removed or driven out of sight by laborers or their vehicles as they work nearby. When it comes time to excavate in the area again, no one may remember exactly where the stakes were previously. As-built drawings may have to be consulted and a survey team called in to relocate the buried object.

Visual markers comprising stiff and resilient filaments have been added to stakes to make for a more robust marker. These filaments step on or run over by a vehicle and have a good chance of at least some of the filaments bouncing back to an upright position afterwards. For example, U.S. Pat. No. 3,267,901, entitled GRADE INIDCATOR STAKE, issued Aug. 23, 1966 to Carroll, describes a stake with a bundle of nylon filaments clamped to the top of the stake by a staple. When the staple is driven into the top of the stake, the filaments become semi-erect and extend upward and outward from the top of the stake. U.S. Pat. No. 3,903,835 entitled GRADE INDICATOR STAKE FLAG HOLDER, issued Sept. 9, 1975, also to Carroll, describes a marker stake with a flag or filament bundle folded at the center and retained by a metal crimp band. The band includes a staple attaching the banded filaments to the top of a wooden stake. U.S. Pat. No. 5,501,170, entitled GRADING STAKE WITH INDICATOR FLAG, issued Mar. 26, 1996, to Walsh, describes a bundle of colored filaments fastened at one end to the top of a stake by a tape wrap wound around the end of the filament bundle and the top of the stake. This arrangement is to avoid the problems associated with using a stake with an indicated flag attached by means that penetrate the stake. See also e.g. U.S. Pat. No. 5,044,303, U.S. Pat. No. 5,172,237, U.S. Pat. No. 5,215,033, U.S. Pat. No. 6,142,882, U.S. Pat. No. 6,832,575, and U.S. Pat. No. 7,382,266.

Yet merely adding filaments to a stake is unsatisfactory in some situations. A stake can easily be pulled out and driven back in at another location. Also, a stake by itself does not by itself indicate how deeply the object is buried. This information can be written on the stake or in an office record, but these can fade or be lost. What is needed is an excavation safety marker that can be attached directly to the object before it is buried in such a manner that a portion of it will still be visible above ground after the object is buried.

Magnets are well known for having the capacity to attach themselves to objects made of ferromagnetic materials. Magnets have been used in fields unrelated to construction to attach a flag or sign to an object such as a vehicle to thereby aid in identifying the vehicle from a distance. For example, U.S. Pat. No. 4,700,655, entitled SIGN SUPPORT STRUCTURE, issued Oct. 20, 1987 to Kirby, describes a support base having a magnet therein, a mast attached to the support base and a flag attached to the mast. The support base has a flat support surface whereby the base can be attached to any metal surface such as the roof or door of a car. See also e.g. U.S. Pat. No. 5,388,536, and U.S. Pat. Pub. No. 2006/0086307. However, the known art does not include the use of magnets in construction to attach visual indicators to buried objects.

### SUMMARY AND ADVANTAGES

A magnetic excavation marker is described below that includes a magnet and a stiff, resilient and brightly colored visual indicator. The marker is used by placing the marker onto an object to be protected, such as a manhole cover or valve. The magnet attaches the marker to the protected object with magnetic force. The marker will then protect the object by providing a highly visible indication of the presence of the object, even if the object is buried. The stiff and resilient qualities of the visual indicator ensure that it will remain upright and visible, even after it has been stepped on or run over. A handle is attached to the magnet or to a housing holding the magnet. The handle gives a user added leverage to aid in overcoming the force of the magnet when the user desires to remove the maker from the protected object.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of a magnetic excavation safety marker and, together with the detailed description, serve to explain the principles and implementations of Applicant's magnetic excavation safety marker. The figures associated with this disclosure typically are not drawn with dimensional accuracy to scale but rather drafted with a focus on clarity of viewing and understanding.

FIG. 1 shows an embodiment of a magnetic excavation marker.

FIG. 2 shows a three typical uses for the marker.

FIG. 3 illustrates the process of burying an object protected by the magnetic excavation marker.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

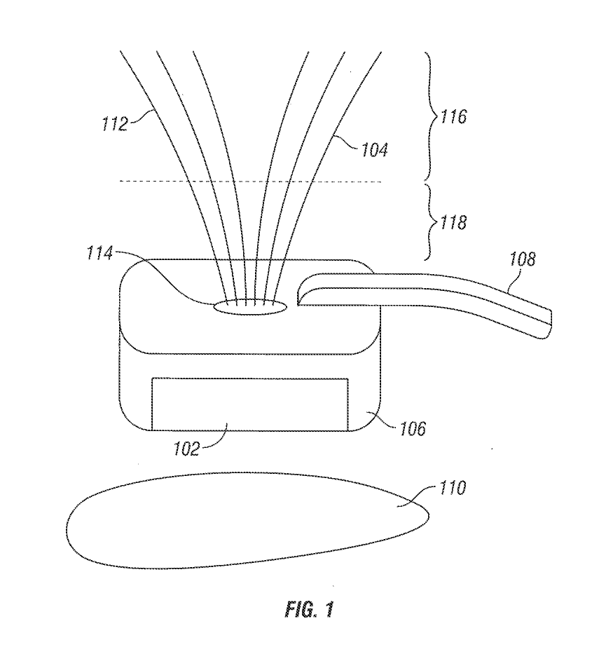

FIG. 1 shows an embodiment of a magnetic excavation marker 100. The marker 100 includes a magnet 102, a stiff, resilient and brightly colored visual indicator 104, a housing 106 and a handle 108. The marker 100 is used by placing the marker 100 onto an object 110 to be protected, such as a manhole cover or valve. The magnet 102 attaches the marker 100 to the protected object 110 with magnetic force. The marker 100 will then protect the object 110 by providing a highly visible indication of the presence of the object 110, even if the object is buried.

The housing 106 holds the magnet 104 and has an attachment 114 for one end of the visual indicator 104. In this embodiment, the attachment 114 is made with an epoxy putty, but in other embodiments, the attachment 114 is some other attachment means such as a clamp bolted to the housing 106 and clamped to the visual indicator 104. In some embodiments, the visual indicator 104 and the handle 108 are attached directly to the magnet 102. In such a case, the housing 106 could be said to not be present or that the magnet 102 is effectively the same thing as the housing 106.

In this embodiment, the visual indicator 104 is a bundle of filaments 112 made of polypropylene or some other material that is stiff and resilient. The filaments 112 are held together at their ends nearest the housing 106 by a two part resin. In other embodiments, the filaments 112 are held together by other means such as using heat to fuse the filaments 112. In other embodiments, the visual indicator 104 is a single filament or wire with a flag on the end farthest from the housing 106.

The color of the visual indicator 104 changes color part way up from the housing 106, dividing the visual indicator 104 into an upper indicator portion 116 and a lower indicator portion 118. The upper indicator portion 116 is farther from the housing 106 and magnet 102 than is the lower indicator portion 118. In this embodiment, the lower indicator portion 118 extends 6 inches above the housing 106, but in other embodiments has different lengths. The color of the lower indicator portion 118 is neon pink, but in other embodiments is some other color. The color of the upper indicator portion 116 is a vivid contrast with the color of the lower indicator portion 118 and follows a code that represents a type of object 110 to be protected. For example, a marker 100 to protect an object 110 associated with a water system has a blue upper indicator portion 116, an object 110 associated with a sewer system has a green upper indicator portion 116, and an object 110 associated with a storm drain system has a red upper indicator portion 116. In other embodiments, a different color coding may be used or a single color for types of objects 110. The color difference between the upper indicator portion 116 and lower indicator portion 118 is useful to workers excavating around the protected object 110. The workers may use faster, mechanized methods of excavating, such as a backhoe, until encountering the different color of the lower indicator portion 118. The workers can then switch to a slower, more careful method of excavation, such as a hand shovel, until the protected object 110 is uncovered.

The length of the visual indicator 104 is two feet in this embodiment, but is of differing lengths in other embodiments. A longer visual indicator 104 allows the marker 100 to protect objects 110 that are buried deeper.

The handle 108 is used to remove the marker 100 for the object 110 protected. The handle 108 is elongated and rigid, giving a user of the marker 100 increased leverage for overcoming the force of the magnet 102. A shorter or less rigid handle 108 is used in other embodiments, but will not provide as much leverage and the user will have to apply more force.

The magnet 102 in this embodiment is a permanent magnet produces 50 pounds of force when in contact with a surface made of ferromagnetic materials. In other embodiments, stronger or weaker magnets may be used. However, magnets stronger than 60 pounds may be too hard to remove when desired, and magnets weaker than 30 pounds may be too easily displaced accidently by excavation activity. The magnet 102 in this embodiment has a circular or ring shape, but those skilled in the art would realize that other shapes may be used such as a bar or a horseshoe form. In other embodiments, the magnet 102 is an electromagnet.

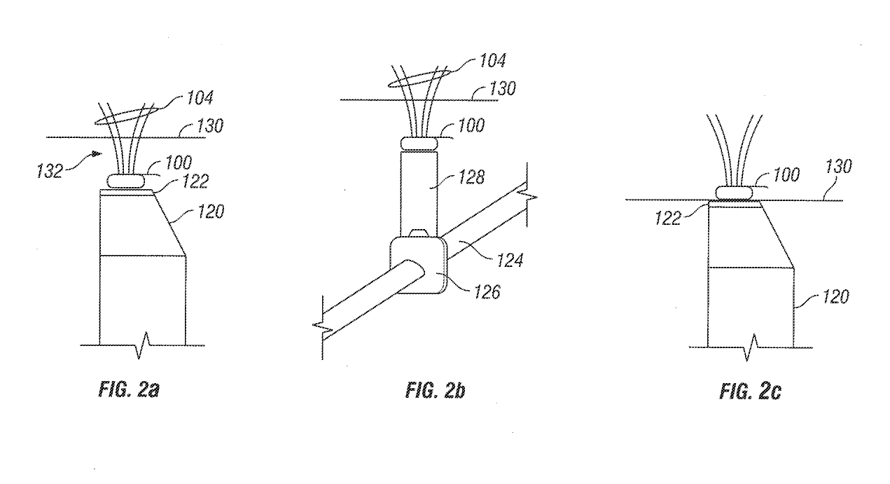

FIG. 2 shows a three typical uses for the marker 100. FIG. 2a shows the marker 100 protecting a buried manhole 120 by attaching magnetically to a manhole cover 122 made of ferromagnetic materials. The visual indicator 104 extends up through the earth 132 and above the finished grade 130. FIG. 2b shows the marker 100 protecting a valve 124 that is part of piping system 124. The valve 124 is covered with a valve can 128 made of ferromagnetic materials. The marker 100 attaches magnetically to the valve can 128. The visual indicator 104 extends up through the earth 132 and above the finished grade 130. The marker 100 can be used to protect objects that are not buried as well. FIG. 2c shows a manhole 120 that has a manhole cover 122 that is flush with the finished grade 130.

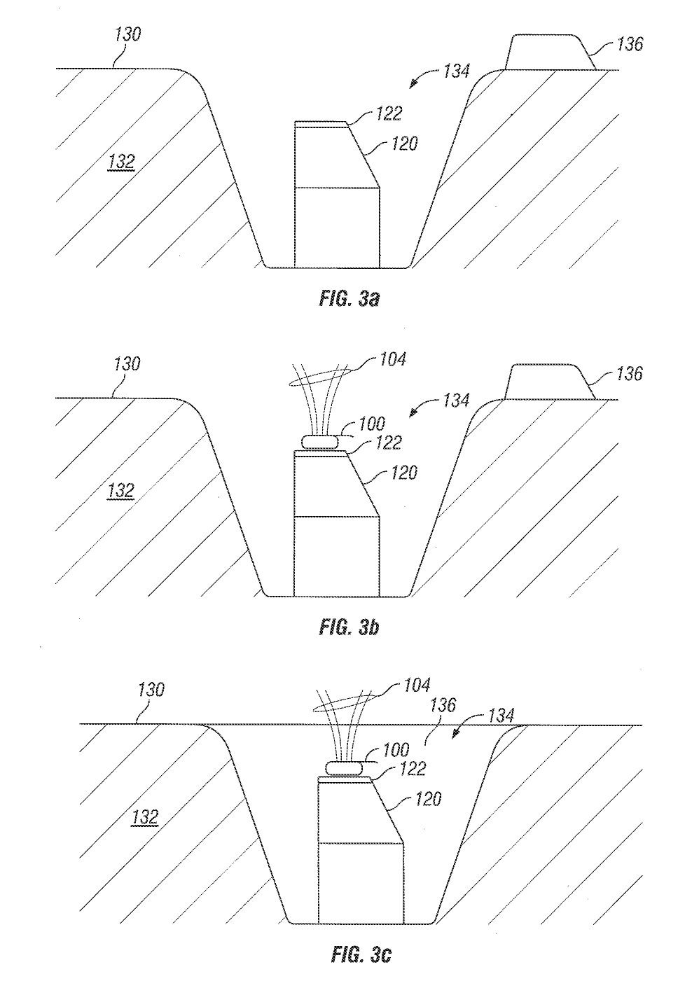

FIG. 3 illustrates the process of burying an object protected by the magnetic excavation marker 100. In FIG. 3a, a hole 134 is dug in the earth 132 and the excavated earth 136 is stored in a pile. The manhole 120 is placed in the hole 134. The manhole 120 is capped by a manhole cover 122. In FIG. 3b, the marker 100 is attached to the manhole cover 122 with magnetic force. The visual indicator 104 is long enough to extend above the finished grade 130. In FIG. 3c, the hole 134 is filled in with the excavated earth 136 while taking care to ensure that the visual indicator 140 is not pushed down below the finished grade 120. Thus installed, the marker 100 serves as an indication of the location of the manhole 120.

While particular embodiments of the present invention have been shown and described, it will be obvious to those skilled in the art that numerous modifications and changes may be made to the described embodiments without departing from the scope of the claimed invention. Modifications of the invention, in its various aspects, will be apparent to those skilled in the art, some being apparent only after study, others being matters of routing mechanical, chemical and electronic design. No single feature, function or property of the described embodiments is essential. Other embodiments are possible, their specific designs depending upon the particular application. As such, the scope of the invention should not be limited by the particular embodiments herein described, but should be defined only by the appended claims and equivalents thereof.

We claim:

1. An magnetic excavation safety marker comprising: a magnet; and a coupled to said magnet a long, stiff, and resilient visual indicator.

2. An magnetic excavation safety marker comprising: a magnet; and coupled with said magnet a long, stiff, and resilient visual indicator having a lower indicator portion and an upper indicator portion, the upper indicator portion farther from the magnet than the lower indicator portion, the lower indicator portion of a first color and the upper indicator portion of a second color.

3. An magnetic excavation safety marker comprising: a magnet; and coupled to said magnet a long, stiff, and resilient visual indicator having a plurality of filaments.

4. The magnetic excavation safety marker of claim 1, further comprising a handle coupled to the magnet.

5. The magnetic excavation safety marker of claim 1, further comprising a handle coupled to the magnet extending beyond an edge of the magnet.

6. The magnetic excavation safety marker of claim 1, further comprising a handle coupled to the magnet substantially perpendicular to the visual indicator.

7. The magnetic excavation safety marker of claim 1, further comprising an elongated and rigid handle coupled to the magnet.
